(19) United States
(12) Patent Application Publication
(10) Pub. No.: US 2018/0066438 A1
(43) Pub. Date: Mar. 8, 2018

(54) Solar Powered Heated Roof

(71) Applicant: Ryan White, Otego, NY (US)

(72) Inventor: Ryan White, Otego, NY (US)

(21) Appl. No.: 15/257,880

(22) Filed: Sep. 6, 2016

(51) Int. Cl. E04D 13/10; H02S 40/38

(52) U.S. Cl. CPC E04D 13/103; H02S 40/38

(57) ABSTRACT

A system for removing snow from a rooftop comprising a plurality of interconnected pipes installed on the rooftop configured to provide a fluidic path to carry heat transfer fluid. The plurality of interconnected pipes forms a framework over the rooftop. A roof cover is attached to the interconnected pipes to cover the rooftop. The heat exchange pump circulates the heat transfer fluid through the interconnected pipes to maintain the temperature of the rooftop cover above the freezing temperature for the snow to melt and slide down from the roof. A solar panel charges a rechargeable battery which is configured to supply power to a heater configured to heat the heat transfer fluid. A controller controls the heater and heat exchange pump to supply the heat transfer fluid to the interconnected pipes to heat the roof cover. The roof cover is a combination of fiber added thermally conductive plastic material and plastic polymer.

### FIELD

Example embodiments of the inventive concepts relate to rooftop snow removal systems and methods.

### BACKGROUND

Conventional snow removal systems or methods are manual and mechanical. There is a need for an advanced system and method for removing snow, in particular, from rooftop. Such systems and methods will increase the lifespan of a roof, and reduce the unnecessary cost of repair.

### SUMMARY

The inventive aspect described in the specification can be embodied in a system for removing snow from a rooftop, the system comprising: a plurality of interconnected pipes installed on the rooftop configured to provide a fluidic path to carry heat transfer fluid, the plurality of interconnected pipes forming a framework over the rooftop; a roof cover attached to the interconnected pipes to cover the rooftop; a heat exchange pump configured to circulate the heat transfer fluid through the interconnected pipes; a solar panel configured to charge a rechargeable battery which is configured to supply power to a heater configured to heat the heat transfer fluid; and controller to control the heater and heat exchange pump to supply the heat transfer fluid to the interconnected pipes to heat the roof cover.

The other inventive aspects can be embodied in a method for removing snow from the rooftop, the method comprising: installing a plurality of interconnected pipes on the rooftop to provide a fluidic path to carry heat transfer fluid, the plurality of interconnected pipes forming a framework to cover the rooftop; and attaching an exterior roof cover to the interconnected pipes to cover the rooftop; circulating the heat transfer fluid through the interconnected pipes by a heat exchange pump; controlling a heater configured to heat the heat transfer fluid and heat exchange pump to supply heated heat transfer fluid to the interconnected pipes to heat the exterior roof cover to a selected temperature.

Other embodiments of the inventive aspect include a system for removing snow from a rooftop, the system comprising: a thermally conductive roof cover attached to the roof to cover the rooftop; a heater configured to supply heat to the thermally conductive roof cover; a solar panel configured to charge a rechargeable battery which is configured to supply power to the heater; and a controller to control the heater to control the heat supply to the roof cover.

The further embodiments of the inventive aspect can be embodied in the system wherein the roof cover is combination of fiber added thermally conductive plastic material and plastic polymer material such as Acrylonitrile butadiene styrene (ABS).

### BRIEF DESCRIPTION OF THE DRAWINGS

The example embodiments of the inventive concept will be better understood from the following brief description taken in conjunction with the accompanying drawings. The drawing FIGS. 1-4 represent non-limiting, example embodiments.

FIG. 1A shows a system for a solar powered heated roof.

FIG. 1B shows an electrical connection for the rechargeable battery and solar panel.

FIG. 2A shows the rooftop cover made from a combination of materials.

FIG. 2B shows the plurality of interconnected pipes.

FIG.3 shows isometric view of the rooftop cover installed on the framework of interconnected pipes.

FIG. 4 shows an example embodiment of electrical connection for the system.

### DETAILED DESCRIPTION

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. in the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not he interpreted in an idealized or overly formal sense unless expressly so defined herein.

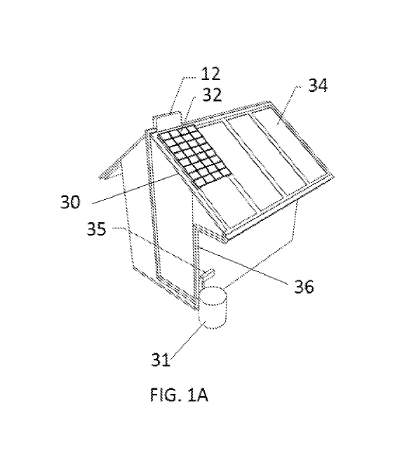

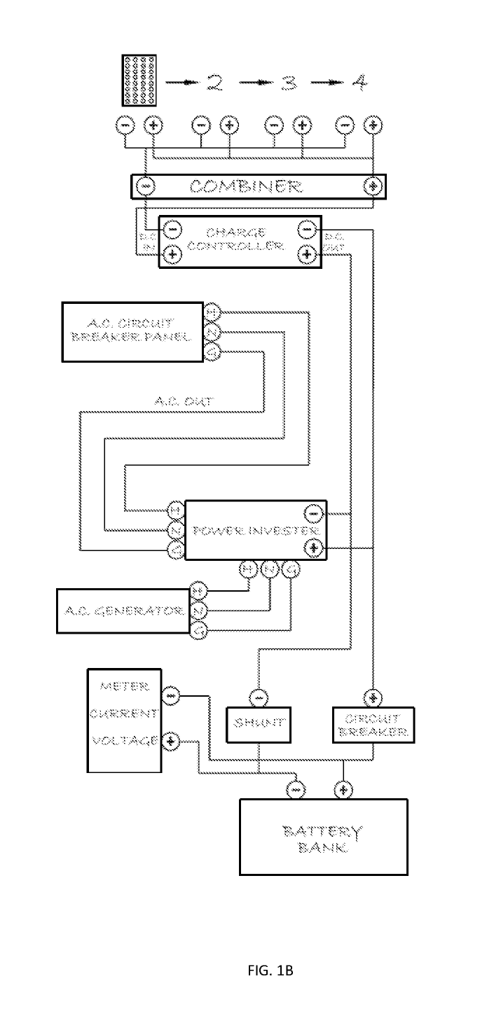

FIGS. 1A-4 show a system for solar power heated roof cover for removing the snow from a rooftop 30. The system includes a roof cover 34 installed on a plurality of interconnected pipes 53, a solar panel 32, a control panel 35, a heat exchange pump 31, and a heat transfer fluid storage tank 12 (such a glycol storage tank) and connecting pipes 36 to the heat exchange pump 31.

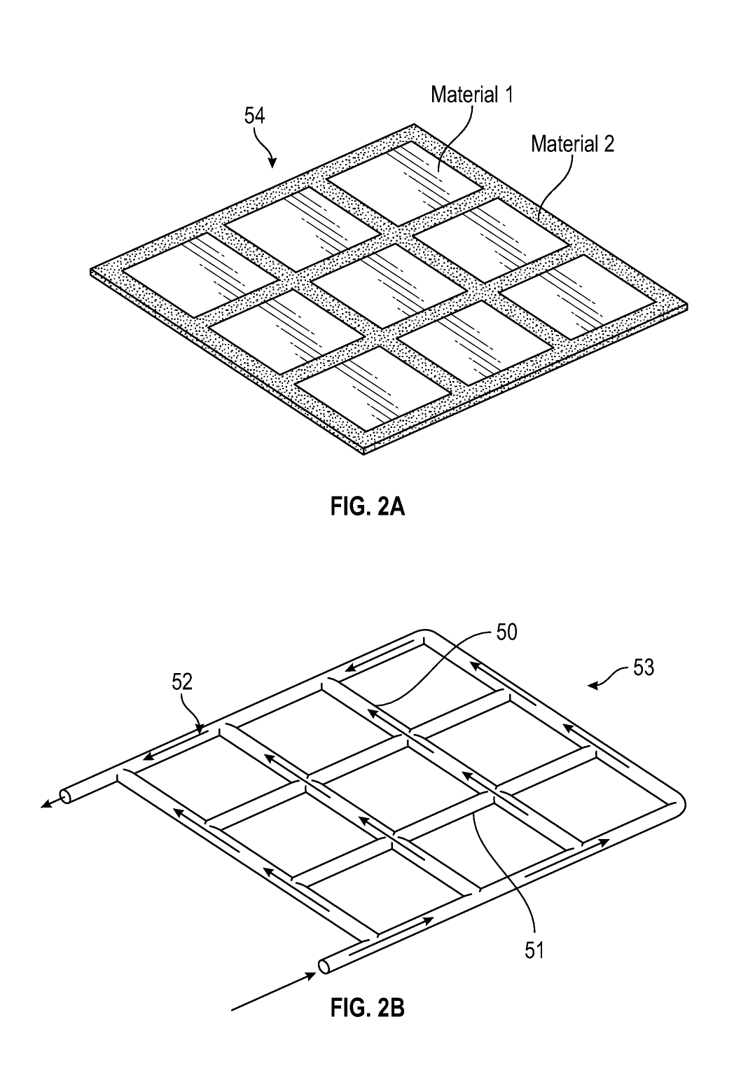

FIG. 2A shows rooftop cover 54 comprised of material 1 and material 2.

FIGS. 2A-2B show a plurality of interconnected pipes 50, 51 for installing on a rooftop 30. The interconnected pipes 50, 51 are configured to provide a fluidic path 52 to carry the heat transfer fluid. The plurality of interconnected pipes 50, 51 form a framework 53.

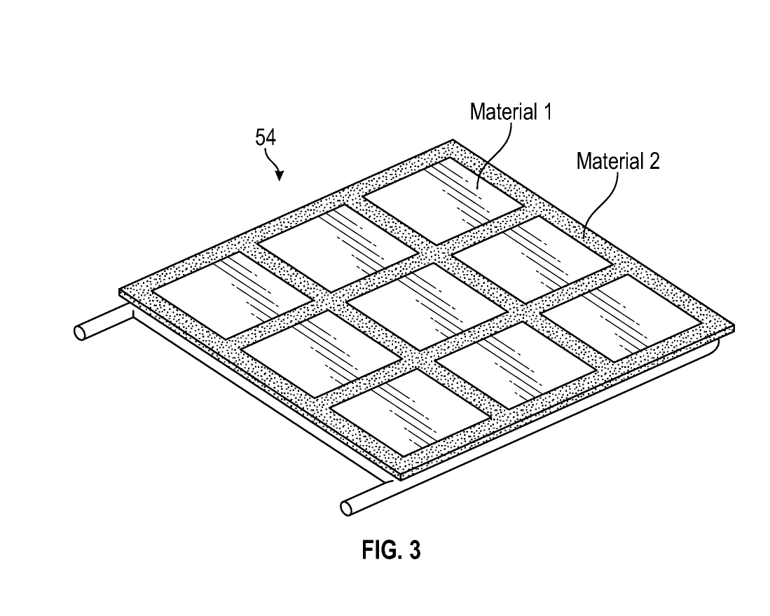

As shown in FIG. 3, rooftop cover 54 is attached to the framework 53 of interconnected pipes 50, 51 to cover the rooftop. A heat exchange pump 31 is configured to circulate the heat transfer fluid 75 through the interconnected pipes 50, 51.

In an embodiment, the heat exchange pump may include a glycol heater 72 and a controller. A solar panel 32 is configured to charge a rechargeable battery which is configured to supply power to the heater configured to heat the heat transfer fluid such. The controller is configured to control the glycol heater 31 in order to supply the heat transfer fluid to the interconnected pipes 51, 50 to heat the roof cover.

In an example embodiment, the interconnected pipes are made of plastic polymer such as Polyvinyl chloride (PVC) and the rooftop cover 54 may be a light weight material and is about ½ inch thick.

In an example embodiment, the rooftop cover is made up of plastic polymer such as Acrylonitrile butadiene styrene (ABS).

In another example embodiment, the roof cover is entirely made up of a fiber added thermally conductive plastic exhibiting thermal conductivity to allow fast heat transfer from the glycol to the rooftop cover.

In another example embodiment, the rooftop cover is combination of fiber added thermally conductive plastic material and plastic polymer such as Acrylonitrile butadiene styrene (ABS).

In a further example embodiment, FIG. 2A shows the thermally conductive material of the rooftop cover (material 2) is distributed in interconnected network to form the rooftop cover along with another material (material 1) and is configured such that the interconnected pipes are in thermal contact with the thermally conductive material of the rooftop cover for efficient heat exchange and control of the temperature of the rooftop. Such configuration of thermally conductive material allows efficient distribution of heat through the rooftop cover.

In a further example embodiment, in the peak of the roof top, a glycol storage and expansion tank and a pump may be installed whereby the glycol may be arranged to flow through the pipes evenly.

in an example embodiment, the control panel 35 is used to control the heat exchange pump 31, and the heater.

In an embodiment, the heat output to heat glycol 75 may be controlled by an electric current flow through a resistive heating element of glycol heater 72. To produce heat in an electric heater, the amount of current passed through the resistive heating element may be regulated by the controller which is set by the control panel 35. In regulating the heat output, the larger is the current passing through the electric heating element, the larger is the heat produced.

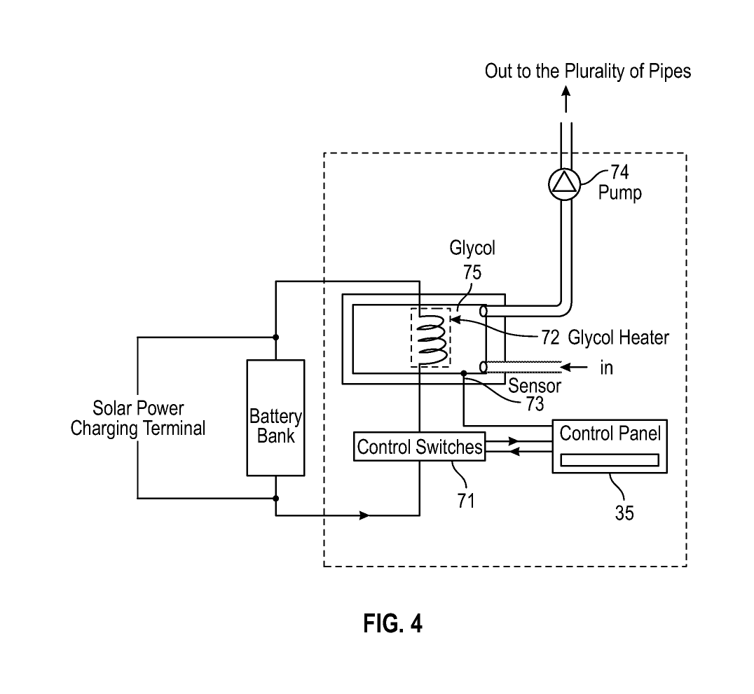

In further example embodiment, as shown in FIG. 4, the glycol heater may also include a temperature sensor 73. One or more sensors may be located towards bottom surface and towards an exit tube. The sensor may be located in a position to sense the glycol temperature at any location within the Glycol tank. The sensor may provide signal corresponding to the detected temperature to the controller which in response to the received signal, generates an output to maintain and regulate the heating cycle of the heater. For example, electric current to the resistor element is controlled to control heat radiation supplied to the Glycol liquid 75.

In example embodiment control switch 71 are controlled to control the current supplied to the heater by the controller. A pump 74 pumps the heated glycol and supplies to the interconnected pipes 50, 51 to maintain a desired temperature of the roof cover.

In further example embodiments, the temperature sensors (not shown) are installed at the various locations of the rooftop cover. The signal corresponding to the temperature value at the rooftop cover is generate and transmitted to the controller to control the circulation of the heated glycol to the interconnected pipes. The controller may control the heater in coordination with heat exchanger pump to control the flow to the interconnected pipes. The controlling includes starting the heater, continuously maintaining, decreasing or increasing the heating, or terminating the heating according to a set point temperature via the control panel for the desired temperature of the roof cover attached to the interconnected pipes.

In another example embodiment, the pump 74 may be controlled manually or by a controller.

In a further example embodiment, the exterior roof cover may be located at about 6 inches above the main roof to provide insulation between the main roof and external rooftop cover which will not allow any snow/ice formation on the rooftop.

The rooftop cover helps to keep the temperature of the roof above freezing. The rooftop cover (the exterior roof) is installed over the top of the main roof on the framework of plurality of interconnected pipes. In an implementation, after installing the exterior roof, the brackets for the solar panels are installed. The brackets can be mounted to the exterior roof. Depending on the size of the roof, the number of solar panels can be selected. The solar panels may be configured in parallel combination to supply charge to the rechargeable battery.

In an example embodiment, the control panel may be located in a desired location chosen by the user.

In another example embodiment, control panel is used to set the controller which is configured to control the glycol heater to monitor and set the desired temperature of the Glycol according to consumer needs.

in an example embodiment, rechargeable battery may be a battery bank of 12 to 14 batteries which may be selected based on the size of the rooftop and the number of solar panels. The battery banks are connected in parallel combination and supply electricity to the glycol heater, pumps and regulators, sensors and control panel. The solar panels (photo voltaic) are configured to charge the battery bank.

In an example embodiment, a combiner may be used to combines all of the direct current generated by the solar panels. The combiner is then connected to a Power converter to convert DC power to AC Power.

In an example embodiment, the wires that connect the batteries together are 8-gauge copper wire.

In a further example embodiment, the system is configured to allow home owner to use their own electric supply to the components of the system.

In a further example embodiment, the system is configured to use 3-4 pumps.

In a further example embodiment, the system is configured to use 12-14 rechargeable Batteries/Battery Bank.

In a further example embodiment, the controller controls the heating of the glycol to keep the roof heated above a freezing temperature such that the roof may not collect snow or ice on the rooftop.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

What is claimed is:

1. A system for removing snow from a rooftop, the system comprising:
a plurality of interconnected pipes installed on the rooftop configured to provide a fluidic path to carry heat transfer fluid, the plurality of interconnected pipes forming a framework over the rooftop;
a roof cover attached to the interconnected pipes to cover the rooftop;
a heat exchange pump configured to circulate the heat transfer fluid through the interconnected pipes;
a solar panel configured to charge a rechargeable battery which is configured to supply power to a heater configured to heat the heat transfer fluid; and
controller to control the heater and heat exchange pump to supply the heat transfer fluid to the interconnected pipes to heat the roof cover.

2. The system of claim 1, wherein the solar panel is installed on the rooftop.

3. The system of claim 1, wherein the solar panel is installed along a top side of the rooftop.

4. The system of claim 1, wherein the plurality of interconnected pipes are made of plastic polymer.

5. The system of claim 1, wherein the roof cover is made of a plastic polymer.

6. A system of claim 1, wherein, the roof cover is comprised of fiber added thermally conductive plastic material.

7. The system of claim 1, wherein the heat transfer fluid is glycol.

8. The system of claim 1, wherein the controller includes a touch control panel and is configured to control the heater to heat the heat transfer fluid to a desired temperature.

9. The system of claim 4, wherein the plastic polymer is Polyvinyl chloride (PVC).

10. The system of claim 5, wherein the plastic polymer is Acrylonitrile butadiene styrene (ABS).

11. The system of claim 8, wherein the desired temperature is a range of temperature from 60 degree F. to 85 degree F.

12. A method for removing snow from rooftop, the method comprising:
installing a plurality of interconnected pipes on the rooftop to provide a fluidic path to carry heat transfer fluid, the plurality of interconnected pipes forming a framework to cover the rooftop and;
installing an exterior roof cover to the interconnected pipes to cover the rooftop;
circulating the heat transfer fluid through the interconnected pipes by a heat exchange pump; and
controlling a heater configured to heat the heat transfer fluid and heat exchange pump to supply heated heat transfer fluid to the interconnected pipes to heat the exterior roof cover to a selected temperature.

13. The method of claim 12, wherein a rechargeable battery is configured to supply power to the heater configured to heat the heat transfer fluid.

14. The method of claim 12, wherein a solar panel is configured to charge a rechargeable battery.

15. The method of claim 12, wherein the plurality of interconnected pipes are of plastic polymer.

16. The method of claim 12, wherein the exterior roof cover is a plastic polymer.

17. The method of claim 12, wherein the heat transfer fluid is glycol.

18. The method of claim 12, wherein the controller includes a touch control panel and is configured to control the heater to heat the heat transfer fluid to range of temperature from 60 degree F. to 85 degree F.

19. A system for removing snow from a rooftop, the system comprising:
a thermally conductive roof cover attached to the roof to cover the rooftop;
a heater configured to supply heat to the thermally conductive roof cover;
a solar panel configured to charge a rechargeable battery which is configured to supply power to the heater; and
a controller to control the heater to control the heat supply to the roof cover.

20. A system of claim 19, wherein, the rooftop cover is comprised of fiber added thermally conductive plastic material and Acrylonitrile butadiene styrene (ABS).
